(19) United States
(12) Patent Application Publication
(10) Pub. No.: US 2023/0334005 A1
(43) Pub. Date: Oct. 19, 2023

(54) Programmable Calculator And Equation Solver

(71) Applicant: Larry Jean McGee, Eunice, LA (US)

(72) Inventor: Larry Jean McGee, Eunice, LA (US)

(21) Appl. No.: 17/719,484

(22) Filed: Apr. 13, 2022

(51) Int. Cl. G06F 15/02

(52) U.S. Cl. CPC G06F 15/0225

(57) ABSTRACT

A programmable calculator and equation solver is provided that advantageously performs calculations and solves equations with simplicity and efficiency. Preferred embodiments comprise a USB device that comprises a software application that can be executed by a computer operating system and which comprises a multiple document interface application used to enter, calculate and/or run equations or computer coding, a solver application to solve equations, an optional encryption/decryption function, and an optional licensing function.

### FIELD OF THE INVENTION

The invention relates to functions for an advanced programmable calculator and equation solver.

### BACKGROUND OF THE INVENTION

Methods of calculating and solving equations with programmable calculators and devices that do such are known but they could be improved by making them easier to use and more efficient. For example, improved methods are needed to simplify the entry of instructions, comments, formulas, functions, computer coding and data to make related methods and calculators more useful and efficient. In addition, simplifying the conversion of data (e.g., converting numeric values into degrees, minutes, and seconds) would also make such methods and calculators that use such converted data more useful and efficient. Furthermore, the automatic creation of space between math operators and the option to save, view, load, and delete all or parts of formulas and/or variables in a string used to fill in text boxes within an input text box would be advantageous to the user. Also, the ability to view and save the history of processes and more efficient file creation and storage would be helpful. Such useful and needed capabilities (e.g., features) are provided by embodiments of this invention.

### SUMMARY OF THE INVENTION

The embodiments of this invention provide a programmable calculator and equation solver and methods of calculating and solving equations with a programmable calculator and equation solver that has advantageous capabilities. Certain of these embodiments are used to create a text file, which can contain instructions/comments, formulas, and computer coding (e.g., computer programming language instructions), which then is capable of being read from top to bottom, with the result that one or more formulas (i.e., equations) and/or computer coding are applied and/or solutions are generated and output.

The preferred embodiments of this invention are provided on USB drive devices. Other embodiments can be provided on other memory devices. Still other embodiments can be provided in a stand-alone device that can be handheld.

The most preferred embodiments of this invention comprise (i.e., “comprise” meaning include but are not limited to) a programmable calculator and equation solver that comprises a USB device. The USB device comprises a software application that can be executed by a computer operating system. The software application comprises a multiple document interface application, a solver application, an optional encryption/decryption function, and an optional licensing function.

In these most preferred embodiments, the multiple document interface application is capable of displaying multiple documents at the same time, with each document displayed in its own window. The multiple document interface application comprises a text entry module, a CALCULATE module, and a RUN module. The text entry module is capable of being used to create, save, and access one or more documents comprising one or more lines of text, each line of text comprising (a) instructions or comments, (b) one mathematical and/or trigonometric formula, or (c) computer coding. The CALCULATE module is capable of being used to execute instructions comprising a mathematical and/or trigonometric formula. The CALCULATE module reads the lines of text from top to bottom. The CALCULATE module outputs the results of the executed formulas, and the CALCULATE module is capable of converting the outputted results in different forms comprising numerals, radians, degrees, and/or gradients. The RUN module is capable of being used to execute computer programming language instructions. The RUN module reads the lines of text from top to bottom. The RUN module also outputs the results of the executed coding, and the RUN module is capable of converting the outputted results in different forms comprising numerals, radians, degrees, and/or gradients.

In these most preferred embodiments, the solver application comprises a formula input module and a solver module. The formula input module is capable of being used to enter at least one mathematical and/or trigonometric formula that has at least one unknown variable. The solver module is capable of being used to solve the at least one unknown variable in the at least one mathematical and/or trigonometric formula, and the solver module is capable of being used to output the solution of the at least one unknown variable.

In these most preferred embodiments, the optional encryption function is capable of encrypting or decrypting each of the documents, and the optional licensing function is capable of being used to control the use of the software application and limit such use to licensed users.

In certain embodiments of this invention, the CALCULATE module and the RUN module each have the capability of processing text containing numerals, degrees, radians, and/or gradients. In these and other embodiments of this invention, the CALCULATE module and the RUN module have the capability of processing formulas or coding, respectively, by clicking only one control key.

In certain embodiments of this invention, the software application has the capability of converting the outputted results of the CALCULATE module, the RUN module, and the solver module into degrees, minutes, and seconds. In these and other embodiments of this invention, the software application has the capability of saving, viewing, loading, and deleting mathematical and/or trigonometric formulas and/or variables in whole or in part in strings that are capable of being used to fill-in text boxes within an input text box. In these embodiments, the saving, viewing, loading, and deleting of formulas and data is very efficient and simple.

In certain embodiments of this invention, the software application uses Rich Text Format, which permits the text to be efficiently and easily processed in beneficial manner (e.g., by changing fonts, highlighting, etc.).

Advantages of certain embodiments of this invention are that they can include software that is capable of allowing a user to enter trigonometry (“trig”) functions in one formula containing degrees, radians, gradients, and hyperbolic functions (e.g., Sin, Cos, Tan, etc., and are asked to enter “Numeric Value, Variable, or Formula”).

Another advantage of certain embodiments of this invention are that they are capable of computing the output of several formulas after clicking only one control key.

Another advantage of certain embodiments of this invention are that they are capable of converting a numeric value into degrees, minutes, and seconds by simply selecting the text of interest. The conversion capabilities in some of these embodiments are shown as a tool tip.

Another advantage of certain embodiments of this invention are that they provide an option to save, view, load and delete variables and formulas stored in a string used to fill-in text boxes within an input text box.

Another advantage of certain embodiments of this invention are that they automatically create space between math operators.

Another advantage of certain embodiments of this invention (e.g., embodiments using Rich Text Format, such as shown FIG. 12) are that they provide options to automatically color math operators to enhance viewing of formulas.

Another advantage of certain embodiments of this invention (e.g., embodiments using Rich Text Format, such as shown FIG. 12) are that they provide options to search and replace text and are thus capable of altering the font if desired by the user (e.g., change the type, size, color, highlights, script, underline, bold, italicize).

Additional features and advantages of various embodiments will be set forth in part in the description that follows, and in part will be apparent from the description, or may be learned by practice of various embodiments. The objectives and other advantages of various embodiments will be realized and attained by means of the elements and combinations particularly pointed out in the description and appended claims. Further objectives and other advantages will be apparent to a person of skill in the art applying the embodiments of the invention.

### BRIEF DESCRIPTION OF THE DRAWINGS

FIG. 1 is a screen shot of an embodiment of this invention resident on a USB drive.

FIG. 2 is a screen shot of an embodiment of this invention showing a text file in a document that can be accessed and processed by embodiments of this invention.

FIG. 3 is a screen shot of an embodiment of this invention showing a text file in a document that can be accessed and processed by CALCULATE embodiments of this invention and produce the selected output shown in the bottom panel.

FIG. 4 is a screen shot of an embodiment of this invention showing a text file in a document that can be accessed and processed by CALCULATE embodiments of this invention and also produce the selected conversion of radians to degrees shown.

FIG. 5 is a screen shot of an embodiment of this invention showing a text file in a document that can be accessed and processed by CALCULATE embodiments of this invention and seek an input of a numerical value from a user.

FIG. 6 is a screen shot of an embodiment of this invention showing a text file in a document that can be accessed and processed by CALCULATE embodiments of this invention and produce the user selected (i.e., highlighted with a computer mouse) output from two of the formulas that are shown.

FIG. 7 is a screen shot of an embodiment of this invention showing a text file in a document that can be accessed and processed by RUN embodiments of this invention and produce the selected output.

FIG. 8 is a screen shot of an embodiment of a window for an exemplary SOLVER feature of this invention.

FIG. 9 is a screen shot of an embodiment of a window for an exemplary SOLVER feature of this invention where a Circle.txt file was accessed and the Radius formula selected.

FIG. 10 is a screen shot of an embodiment of a window for an exemplary SOLVER feature of this invention with a particular problem to solve shown.

FIG. 11 is a screen shot of an embodiment of a window for an exemplary SOLVER feature of this invention with a particular problem to solve and a solution shown.

FIG. 12 is a screen shot of an embodiment of a window for an embodiment of this invention that uses Rich Text Format.

FIG. 13 is a screen shot of an embodiment of this invention showing a text file in a document that can be accessed and processed by embodiments of this invention to produce an encrpted file for “Text To Sell.”

FIG. 14 is a screen shot of an embodiment of this invention showing a text file in a document that can be accessed and processed by embodiments of this invention that is overlayed by a window showing certain available choices relating to encrypting a file.

FIG. 15 is a block chart of an embodiment of this invention FIG. 14 is a screen shot of an embodiment of this invention showing a text file in a document that can be accessed and processed by embodiments of this invention that is overlayed by a window showing certain available choices relating to encrypting a file.

FIG. 16 is a screen shot of an embodiment of this invention showing a text file in a document that can be accessed and processed by embodiments of this invention wherein “Variables” is selected from the “Options” menu.

FIG. 17 is a screen shot of an embodiment of this invention showing a text file in a document that can be accessed and processed by embodiments of this invention wherein “Undo Redo (On)” is selected from the “Options” menu.

FIG. 18 is a screen shot of an embodiment of this invention showing a text file in a document that can be accessed and processed by embodiments of this invention containing formulas and computer code.

### DETAILED DESCRIPTION OF THE INVENTION

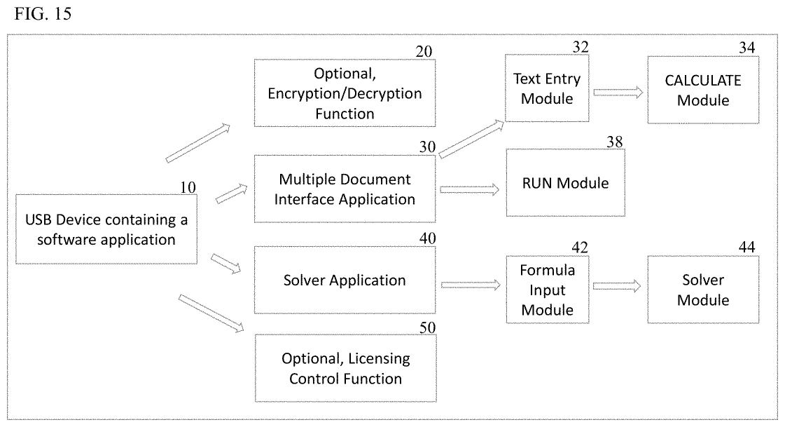

The preferred embodiments of this invention provide methods of calculating and solving equations with advanced programmable calculators and devices that can perform such methods. FIG. 15 is a chart showing components of a preferred embodiment of this invention.

These components comprise a USB device containing a software application 10. The USB device containing a software application 10 comprises a multiple document interface application 30, a solver application 40, an optional encryption/decryption function 20, and an optional licensing control function 50. The multiple document interface application comprises a RUN module 38, a text entry module 32, and a CALCULATE module 34, wherein text is entered by the text entry module 32 and then acted on by the CALCULATE module 34. The solver application 40 comprises a formula input module 42 and a solver module 44, the latter of which acts on the formulas input by the formula input module 42.

Certain of the preferred embodiments of this invention provide capabilities to users through the creation and use of text files stored in documents on devices. The most preferred embodiments of this invention are provided on USB drive devices. The USB drive itself may run the software application of this invention directly (e.g., using USB Auto Run, Plug & Play, or a similar function and a computer's RAM) or it may provide the program for a computer or other device to load and run. Other embodiments can be provided on other memory devices, including stand-alone handheld devices.

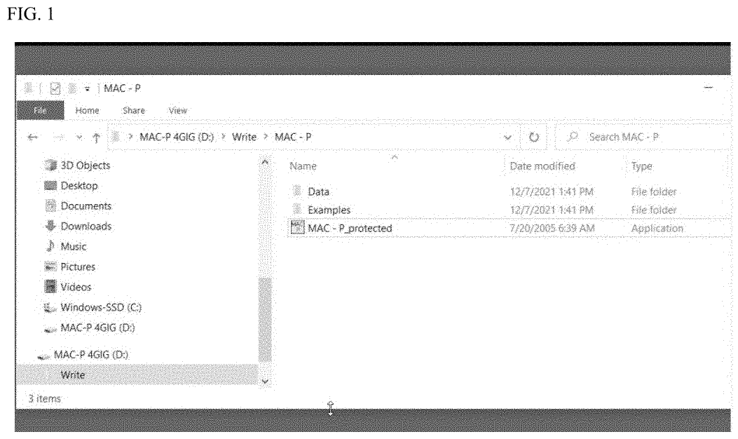

The most preferred embodiments of this invention further comprise a software application with several capabilities (e.g., features/functions). In some of these embodiments, the user can save all text that the user creates in text documents within a text file having the extension .txt. Such a text file preferably may be used to reduce the footprint, for example, on a USB drive, or other memory/storage device. FIG. 1 shows an embodiment of this invention resident on a USB drive.

In some of these embodiments, the software application is resident on a USB drive or other memory/storage device and will, for example, run on any Windows Desktop Operating System, such as Windows 95 and Windows 10. A person of skill in the art can apply the disclosure provided herein and run the software application on other operating systems also. Different programming language can be used for the embodiments of this invention, such as, for example, C, Pascal, Java, Python, JavaScript or PHP, and others.

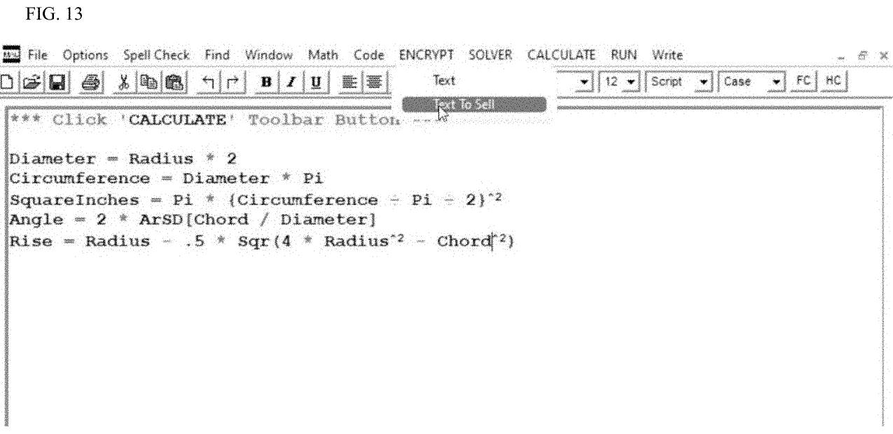

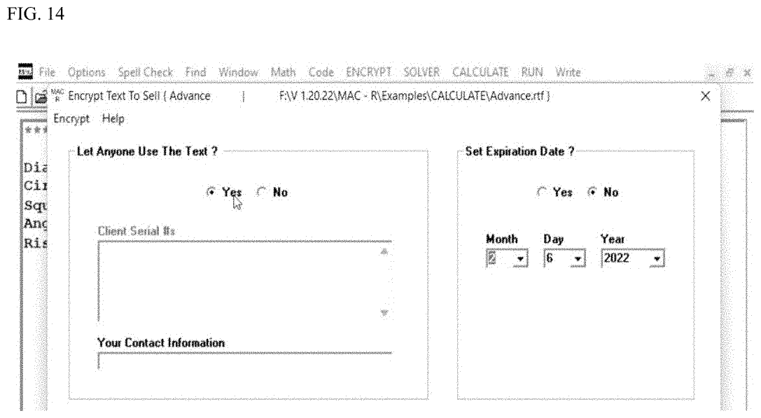

In certain of the most preferred embodiments, these methods are provided with an MDI Main Form for multiple document application and a solver for single document application. Optionally, certain embodiments of this invention provide an encryption/decryption application also. A screen shot from such an encryption/decryption embodiment is provided in FIGS. 13 and 14. Optionally, certain embodiments of this invention provide a licensing control function also.

The most preferred embodiments of this invention comprise a programmable calculator and equation solver that comprises a USB or other similar device. The USB device comprises a software application that can be executed by a computer operating system. The software application comprises a multiple document interface application, a solver application, an optional encryption/decryption function, and an optional licensing function.

MDI Main Form—Multiple Document Interface Application

Multiple document interface applications enable a user to display multiple documents at the same time, with each document displayed in its own window. Such applications have a menu item with submenus for switching between windows or documents. Embodiments of this invention have a multiple document interface application and a toolbar comprising a

CALCULATE and RUN control, among other features. In these most preferred embodiments, the multiple document interface application is capable of displaying multiple documents at the same time, with each document displayed in its own window. The multiple document interface application comprises a text entry module, a CALCULATE module, and a RUN module. E.g., FIG. 15.

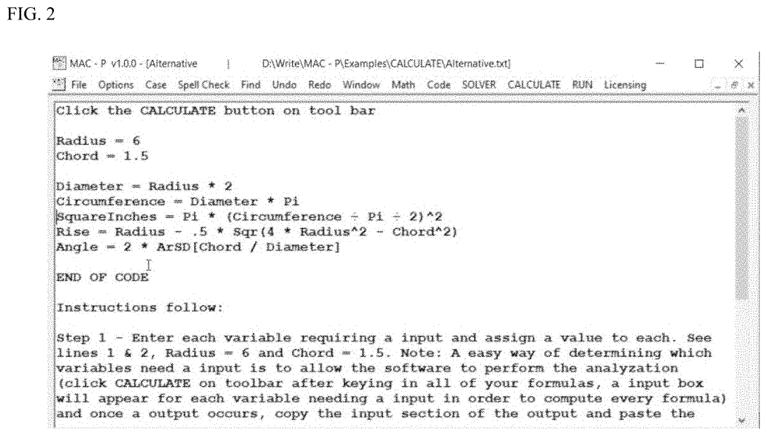

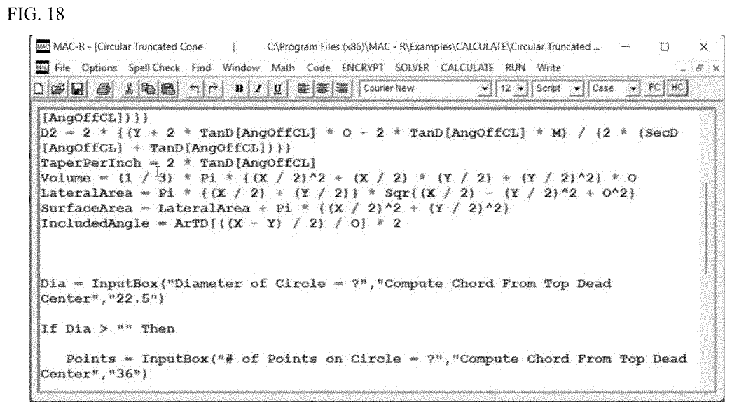

Text Entry Module. The text entry module is capable of being used to create, save, and access one or more documents comprising one or more lines of text, each line of text comprising (a) instructions and/or information (e.g., or other non-executable formulas), or (b) one mathematical and/or trigonometric formula, or (c) computer code. Thus, the user accesses the software application and enters (a) instructions for the user, as an example, or (b) a mathematical and/or trigonometric formula on each line of text, or (c) computer code, all in the same document. For example, FIG. 2 shows a line of instructions or comments (i.e., “Click the CALCULATE button on tool bar”) as well as several lines of formulas (e.g., “Circumference=Diameter*Pi”). FIG. 18 shows lines of formulas (e.g., “IncludedAngle=ArTD[((X−Y)/2)/0]*2”) and lines of computer code (e.g., “If Dia>” “Then”). Having a text file that can include each of these instructions, formulas, and computer code, which can be processed, is a valuable feature of certain embodiments of this invention. For formulas, the user can choose “CALCULATE”, and for computer code, the user can choose “RUN.” This ability to have a text file with instructions, formulas, and computer code, can, for example, aid in the teaching, illustrating, or experimenting with the data and formulas (e.g., be part of a digital textbook on mathematics).

Indications that a line of text is a formula include the use of the equals (“=”) sign somewhere in the line. Indications that a line of text should be processed also can include characters, such as the “'” character on keyboards. In addition, certain embodiments of this invention allow the user to select which lines to process (e.g., by selecting text with a computer mouse).

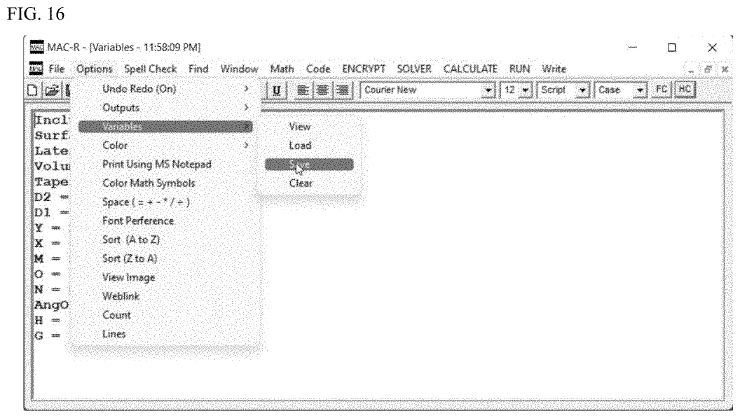

Preferred embodiments permit the user to save, view, load, and delete mathematical and/or trigonometric formulas and/or variables in whole or in part in strings that are capable of being used to fill-in text boxes within an input text box. In these embodiments, the saving, viewing, loading, and deleting of formulas and data is very efficient and simple. Thus, for example, a user can save a variable and view, load, save, and clear those variables for use later (e.g., for plugging into an input text box). FIG. 16 shows an example of this feature and drop-down menus that are associated with it.

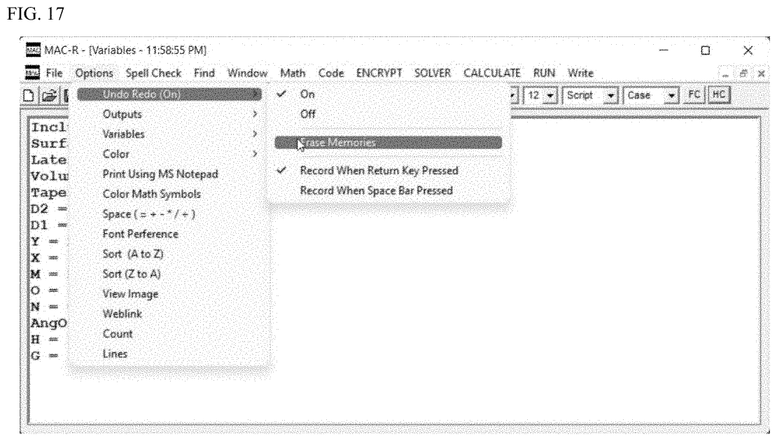

Another useful embodiment is the “Undo Redo (On)” choice from the “Options” menu. FIG. 17. As shown in this figure, the user can erase memories (e.g., from RAM in a USB device embodiment), of, for example, any of the variables that were saved. The user can also choose how they desire any recording to occur, as also shown in this figure.

CALCULATE Module and tool bar control. The CALCULATE module is capable of being used to execute instructions in each line of text, including executing instructions comprising a mathematical and/or trigonometric formula. In preferred embodiments, the CALCULATE module reads the lines of text from top to bottom. The CALCULATE module also outputs the results of the executed instructions, and the CALCULATE module is capable of converting the outputted results in different forms comprising numerals, radians, degrees, and/or gradients.

Certain embodiments of this invention provide a “CALCULATE Tool Bar Control.” With this feature, the user is capable of creating, viewing, and working with multiple documents to enter keyboard text representing mathematical formulas in each document and then click a tool bar control labeled CALCULATE to analyze the document (e.g., and the formulas it may contain) and potentially provide an answer.

With certain of these embodiments, the user first creates and/or selects such a document containing text. FIG. 2 shows an example of such a text file. For this example shown in the figure, the user enters each variable requiring an input and assigns a value to each. See lines 1 & 2, Radius=6 and Chord=1.5 in FIG. 2. A way of determining which variables need an input in this example is to allow the software to perform the analyzation (e.g., click CALCULATE on the toolbar after keying in all the formulas, and an input text box will appear for each variable needing an input in order to compute every formula) and once an output occurs, copy the input section of the output, and paste them into the file. The variable can be entered in from the keyboard, or it can be retrieved from memory (e.g., “load” as shown in FIG. 16), as examples.

In the embodiment shown in FIG. 2, the software will always analyze the text from top to bottom. In addition, the text “END OF CODE” instructs the software to stop collecting any lines of text that follow for analyzation. For this example, five numeric output calculations can occur with the “Angle” being the last one shown. If a single quote character—'—is placed before that line in the text, the software will not collect that line of text.

As shown in the example of FIG. 2, after creating or accessing the text file, the user then selects a tool bar control labeled CALCULATE. The application of this embodiment then examines the document for errors, and if no errors are found, the application applies one or more numerical outputs for each formula in the document, which will be displayed within an additional document that stays hidden until an output is produced.

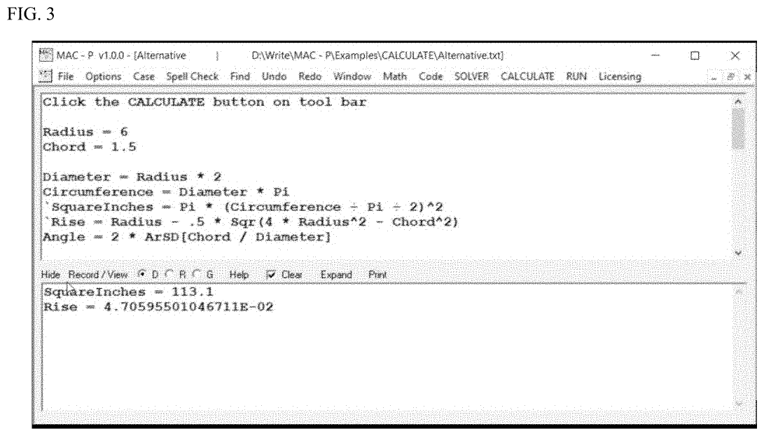

Optionally, prior to the user selecting the tool bar control labeled CALCULATE, the user can use a special keyboard symbol (e.g., ') and apply it at the beginning of one or more formulas to instruct the application to display only the formulas that contain the special keyboard symbol. FIG. 3 (output shown in bottom pane of screen shot).

Certain embodiments of the software application of this invention have the capability of computing formulas containing trig functions in degrees, radians, gradients, and/or the product of hyperbolic functions all in one formula. An example of some of these embodiments of this invention requires the application of special text to use when entering trig functions in degrees, radians, gradients, and/or the product of hyperbolic functions. One such embodiment of a translator/code to translate special text for trig functions that allows a user to enter trig functions all in one formula in degree, radians, and gradients is:

Output=Sin D[5]+Tan R[9]+Cos G[6]

Output=Output=0.6

The “D” prior to the square bracket “[” instructs the software to compute in degrees. For example, a=Sin D[5] a=8.71557427476582E−02.

The “R” prior to the square bracket “[” instructs the software to compute in radians. For example, b=Tan R[9] b=−0.45231565944181.

The “G” prior to the square bracket “[” instructs the software to compute in gradients. For example, c=Cos G[6] c=0.99556196460308.

For hyperbolic trig functions, in certain of these embodiments, the user enters text in a format such as standard Visual Basic 6 computer code:

W=3

x=((Exp((W))−Exp(−(W)))/2)−Hyperbolic Sine

x=10.0178749274099

Certain embodiments of the software application of this invention provide that when clicking the tool bar control labeled CALCULATE, the software analyzes the document or selected text from top to bottom.

Certain embodiments of the software application of this invention provide that should the user select a portion of text in a given document (e.g., by marking it with a symbol or highlighting and thus selecting it with a mouse), only that portion of text within the document that is selected is analyzed.

RUN Module and tool bar control. The RUN module is capable of being used to execute computer programming language instructions comprising mathematical and/or trigonometric formulas. The RUN module reads the lines of text from top to bottom. The RUN module also outputs the results of the executed instructions, and the RUN module is capable of converting the outputted results in different forms comprising numerals, radians, degrees, and/or gradients. Certain embodiments of this invention provide a “RUN Tool Bar Control.” With this feature, a computer programming language such as Visual Basic 6 is used to develop text/source code to be then translated and executed.

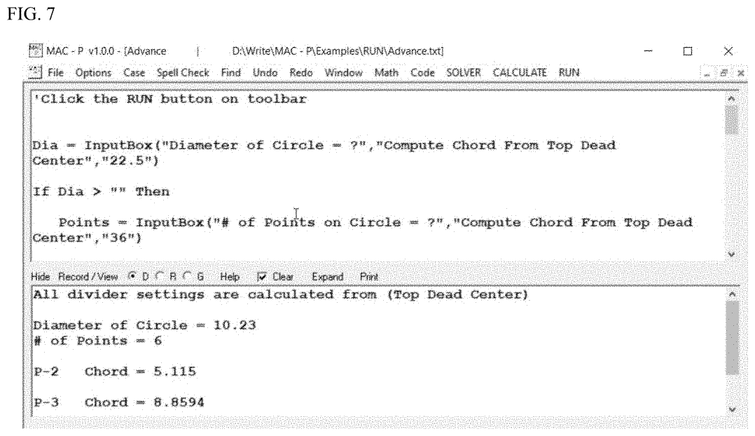

In certain of these embodiments, when clicking the tool bar control labeled ‘RUN’, the software analyzes the document or selected text from top to bottom. FIG. 7 is an example of a window relating to the RUN control of embodiments of this invention.

In some of these embodiments, the user can select a portion of text (e.g., by marking it with a “'” symbol or selecting it by highlighting it with a mouse), and only that portion of text within the document selected is analyzed.

In certain of these embodiments with the RUN Tool Bar Control, all of the trig functions/text features mentioned above for the CALCULATE Tool Bar Control can be used when attempting to execute the source code after the user clicks the RUN control.

SOLVER—Single Document Application

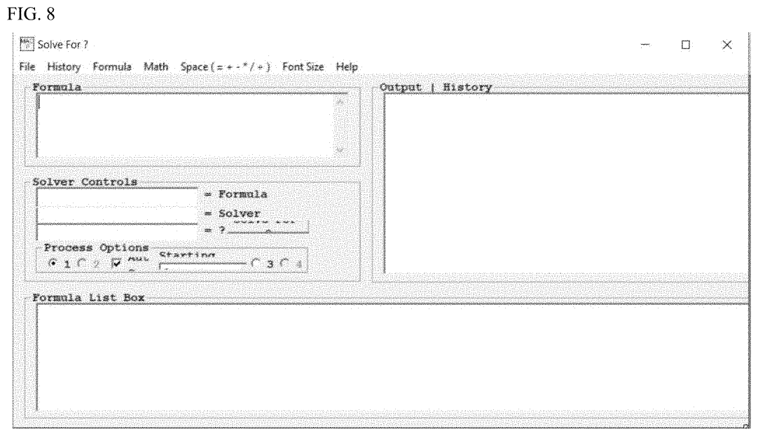

In certain embodiments of this invention, a solver application is provided that is used as an option for the user to solve for an unknown numeric value in formulas understood to be incapable of being transposed but which can be used to compute for an unknown numeric value (e.g., should the user decide to not bother with transposing a formula to compute for an unknown numeric value). FIGS. 8-11 are each a screen shot of embodiments of windows for exemplary SOLVER features. FIG. 15 shows an embodiment of a solver application 40 that comprises a formula input module 42 and a solver module 44.

In some of these embodiments, the user inputs formulas using a keyboard or other input device. When the user presses a certain keyboard key, such as the keyboard ENTER key, the software is instructed to analyze a document or selected text in order to perform a calculation. If variables are inside the formula, an input box will appear requesting an input for each variable.

In certain embodiments, formulas are entered using a keyboard or similar device. In some embodiments, when the user clicks a “Solve” control, the software is instructed to analyze the document or selected text and it will attempt to compute for an unknown variable if such is possible. An unknown can be directly entered in the formula using a “?” mark, for a simple example of addition to show how the invention works conceptually:

8+?

The “?” mark is understood to be the unknown variable. Alternatively, once “Solve” control is clicked and there is an unknown variable, an input box appears requesting an input and the user can enter either a numeric value or the “?” mark.

In certain embodiments, the user can save a formula to a list box on the Solver form and edit the list box to remove one or more formulas.

In certain embodiments, the user can save formulas contained in the list box or outputted text inside a text box (e.g., a “History” text box) to a text file.

In certain embodiments, special text associated with trig functions (see description above) used in the MDI Main Form can also be used in the Solver application.

In certain embodiments, the user can use a function (e.g., “Auto” feature) to solve for an unknown or, alternatively, the user has the choice to select one Process Option at a time by un-checking the Auto check box control until the unknown is computed, provided it is possible.

In certain embodiments, the history of the use of the Solver function can be saved and referenced later.

In the most preferred embodiments, the solver application comprises a formula input module and a solver module. E.g., FIG. 15. The formula input module is capable of being used to enter at least one mathematical and/or trigonometric formula that has at least one unknown variable. The solver module is capable of being used to solve the at least one unknown variable in the at least one mathematical and/or trigonometric formula, and the solver module is capable of being used to output the solution of the at least one unknown variable.

Encryption Function

Certain embodiments of this invention can be used to encrypt and/or decrypt the text file. In preferred embodiments, the text can be encrypted and/or decrypted by either the CALCULATE or RUN control on the tool bar in some of these embodiments. For example, encrypted text can be analyzed by either the CALCULATE or RUN control that are each capable of running/analyzing Visual Basic 6 computer code.

An example of such an application is where a sender and a recipient each have a USB drive that contains applicable copies of an embodiment of the software application of this invention. The sender would first choose a particular document with text and then click an ENCRYPT toolbar button provided in the software application. A dropdown menu in this embodiment asks the user to select whether the subject matter is text or text to sell. FIG. 13. Another menu choice in this example asks whether to “Let Anyone Use The Text” with a yes and no toggle. FIG. 14. If no is chosen, the sender may be prompted to set particular identification information (e.g., a password, a client serial number, contact information), which will determine whether a recipient will be allowed to use the text. An expiration date can also be chosen. The text is then encrypted by methods known to a person of skill in the art by clicking on the CALCULATE toolbar button.

If the person to whom the encrypted text is sent (the recipient) also has an applicable embodiment of the encryption application of this invention on, for example, a USB drive, the recipient can then access the text file, and then click the CALCULATE Toolbar Button on the recipient's application and if anyone is allowed to use the text, the CALCULATE capability will decrypt the text. As indicated, in some embodiments, the recipient must enter identification information that the sender has set (e.g., a password, a client serial number, contact information). In some of these embodiments, the text is never visible to the recipient regardless of whether such use required identification information, although it may still be usable (e.g., the text may be usable for the CALCULATE function but never viewable by a recipient). Optionally, back door access is provided to the encryption application for the purposes of, for example, security and/or law enforcement.

Licensing

Certain embodiments of this invention have licensing control. As an example of these embodiments, the user chooses Licensing on the toolbar, selects the particular device with the embodiment of this invention resident, enters a serial number for the embodiment of this invention, and then receives an encrypted key from a licensing agent. When the key is entered a file is generated and inserted into the folder containing the embodiment of this invention, the Licensing control on the toolbar disappears and the user can use the embodiment.

The subject matter of this disclosure is now described with reference to the following examples. These examples are provided for the purpose of illustration only, and the subject matter is not limited to these examples, but rather encompasses all variations which are evident as a result of the teaching provided herein.

Additional Preferred Embodiments

In certain embodiments of this invention, the CALCULATE module (and the RUN module in executing computer coding) each have the capability of executing instructions in the mathematical and/or trigonometric formulas and/or in using variables containing numerals, degrees, radians, and/or gradients. In these and other embodiments of this invention, the CALCULATE module and the RUN module have the capability of executing instructions of one or more mathematical and/or trigonometric formulas and/or computer coding, respectively, by clicking only one control key (e.g., “CALCULATE” or “RUN”). In certain embodiments of this invention, the software application has the capability of converting the outputted results of the CALCULATE module, the RUN module, and the solver module into degrees, minutes, and seconds. In these and other embodiments of this invention, the software application has the capability of saving, viewing, loading, and deleting mathematical and/or trigonometric formulas and/or variables in whole or in part in strings that are capable of being used to fill-in text boxes within an input text box. Thus, the saving, viewing, loading, and deleting of formulas and data with these embodiments is efficient and simple.

### Example 1

In an embodiment of this invention that was made and operated, a software application is provided on a USB drive (or alternatively a flash drive). FIG. 1 (MAC-P 4GIG (D:)). This example works with a Windows 10 operating system. An exemplary text file that is compressed is imported to work with. FIG. 2. This example in FIG. 2 shows the available toolbar in this embodiment.

As an example, the user first develops each formula on a separate line in the text file. Text files can be saved and accessed. Next, the user clicks the CALCULATE control on the toolbar, in which case if no individual formulas are selected by the user (e.g., by highlighting one or more lines of text with a mouse or placing a character in the front of one or more text lines), the entire document (unless, for example, an “END OF CODE” or similar instruction is placed in the file, which will stop the analysis from proceeding further) will be analyzed. The user then enters a numeric input or formula for each variable when requested. Examples of input could be the number 11, or a formula such as 2+Sqr(81).

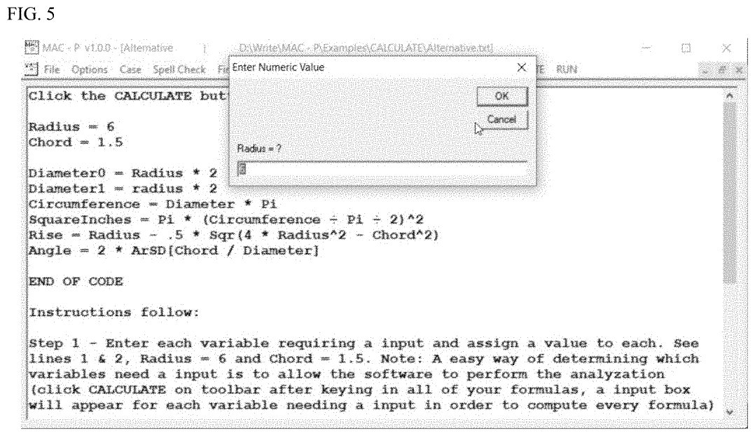

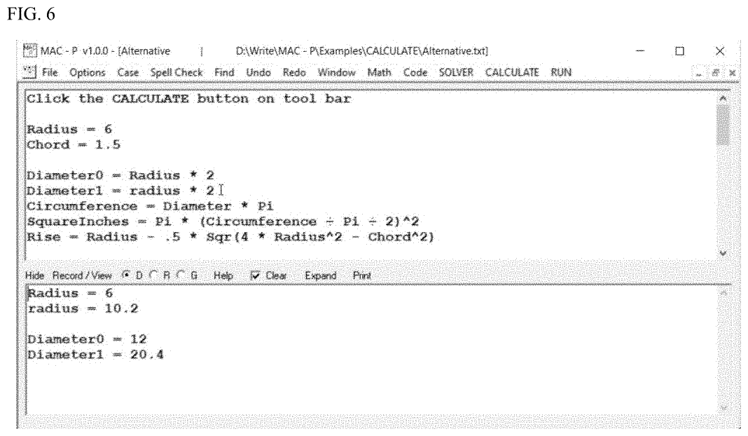

The amount of space between text in the file shown in FIG. 2 does not matter because the file is compressed. In this embodiment, the variables are case sensitive and can be up to 50 characters in length (e.g., “Diameter” is an example of a variable in FIG. 2). If a variable such as “Diameter0” is chosen from the fourth line of text, the user clicks CALCULATE and then the embodiment asks the user for a Radius value to input. FIG. 5. Once the value for Radius is input (only numerical inputs are allowed), the embodiment solves the formula and the Diameter is then output on another pane. FIG. 6 (showing the output values for Diameter® from the Radius, and Diameter1 from the radius, both of which are case sensitive formulas).

If a certain keyboard symbol (e.g., ') is placed before a line of text, when the CALCULATE function is chosen, only the output of those lines of text with the symbol will be output. FIG. 3 (showing “SquareInches” and “Rise” as examples of such tagged text lines and the resulting output). Similarly, selecting (e.g., highlighting) a text line (or a portion thereof with a formula) with a mouse and applying the CALCULATE function will limit the output to the selection. An=sign in a line of text generally indicates the line should be analyzed, as long as the line is before an “END OF CODE” entry or not preceded by a—'—character, in this embodiment.

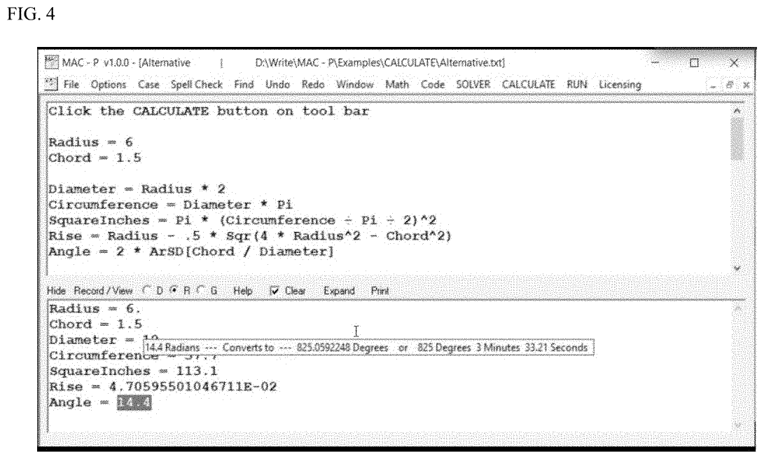

Selecting a numerical output (e.g., 14.4 in FIG. 4), and tagging either “D”, “R”, or “G”, will convert that output to degrees, radians, or gradients, respectively. FIG. 4. The screen view can also be expanded, imploded, printed (e.g., by transferring to NotePad), and recorded (under Options).

An example of a portion of a text file with computer coding and the RUN feature, as well as a portion of an output shown in the bottom pane, is shown in FIG. 7.

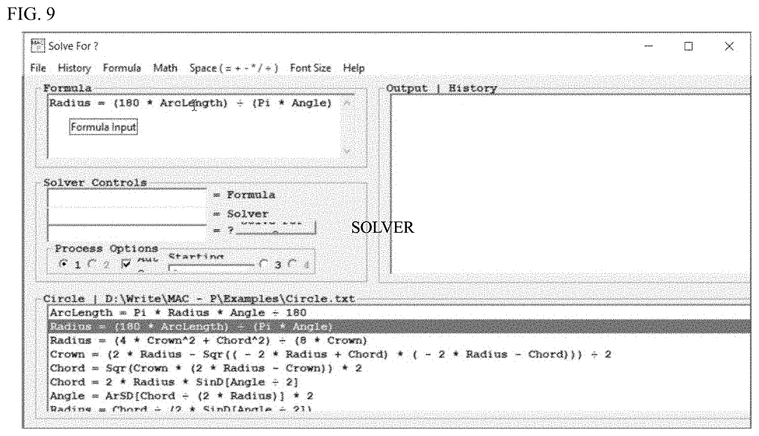

This example also includes an embodiment of a SOLVER feature as shown by FIG. 8 and the window in that figure. FIG. 9 shows an example where a circle.txt file was accessed and the Radius formula selected.

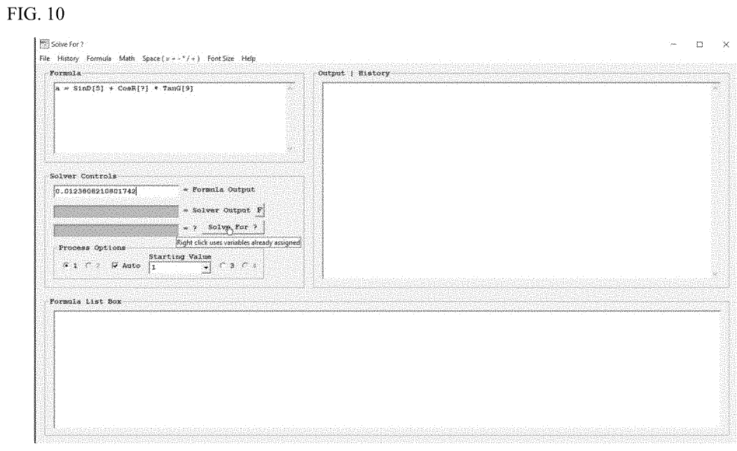

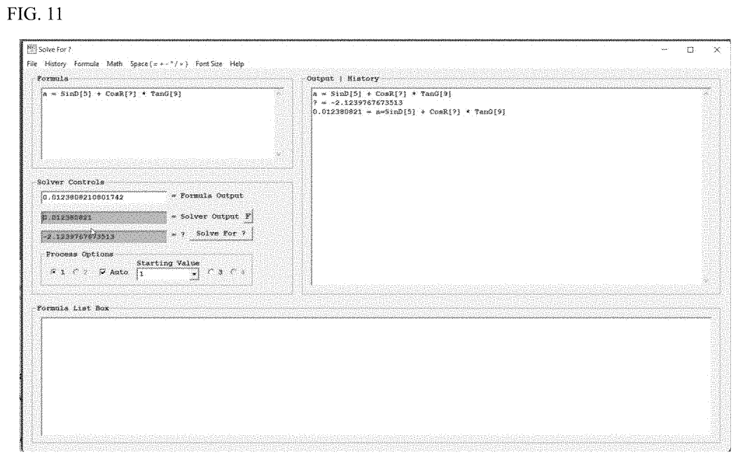

Another example of the SOLVER feature is shown by FIG. 10 and FIG. 11. In that example, the ? in the CosR[?] identifies what is being solved in the equation. The Formula Output should equal the Solver Output. As shown in FIG. 10, the starting value was set at 1, it was set on Auto, and the embodiment will go through the process of determining what the value in the Solver Output text box should be. The results are shown in FIG. 11. The formula's used in the SOLVER feature can be saved in the Formula List panel of this embodiment. The output history can also be shown in a panel, or saved in a separate file.

In this embodiment, the drop down “Options” menu allows the user to Undo Redo, make Recordings, access and view Variables (e.g., Save them and later Load them into other input boxes), change Font and add color, Spell Check, Math Functions, Space, View Image (if in file), Sort the files, WebLink, and Count lines. The “Case” menu changes the case of characters. The “Math” menu has the choices of Degrees, Radians, Gradients, Hyperbolic, Root (square, power), Log, Pi, ÷, \hat{ }, { }, ( ) and Group.

In this embodiment, when CALCULATE is chosen, the text is read top to bottom and a line is ignored if it does not contain an equals sign. “End Of Code” text also stops the software from reading the text any further.

In this embodiment, two bitmaps (or jpeg files) can be added to the text file for reference. These images can be used to reference the problem being addressed.

### Example 2

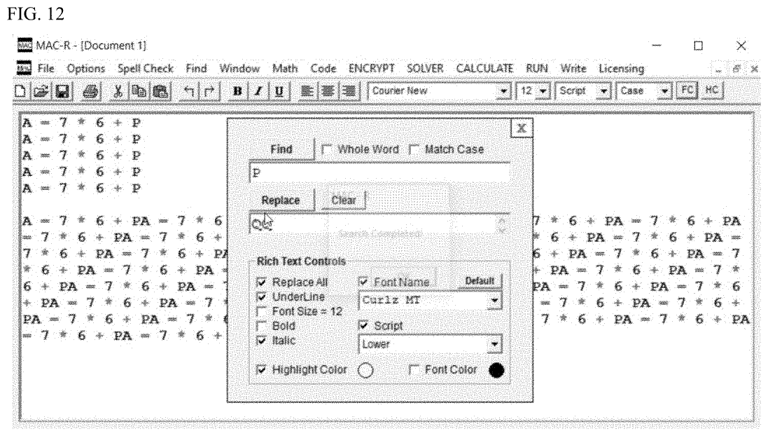

In an embodiment of this invention that was made and operated, a software application that uses Rich Text Format is provided on a computer hard drive. This example was working on a Windows 10 operating system. This example in FIG. 12 shows the available toolbar in this embodiment. This example provides options to automatically color math operators to enhance viewing of formulas. It also provides options to search and replace text and is thus capable of altering the font if desired by the user (e.g., change the type, size, color, highlights, script, underline, bold, italicize). It also allows for cutting and pasting, and copying and pasting, text, such as formulas and/or variables.

### Example 3

In this example, a further description is provided of the capability for a user to select text in a document (e.g., by highlighting the text with a computer mouse) and then select the CALCULATE (or RUN if the text is in computer syntax) option, which will be directed to only the selection. Thus, if the user only wants to CALCULATE the output from two of four formulas in the text (as an example), the user highlights the two formulas of interest and clicks the CALCULATE option. Similarly, if the user only wants to RUN the output from three of six lines of code in the text (as an example), the user highlights the three lines of code in the text and clicks the RUN option.

Particular Applications to Computer Devices

The system applied to this invention may include a plurality of different computing device types. In general, a computing device type may be a computer system or computer server. The computing device may be described in the general context of computer system executable instructions, such as program modules, being executed by a computer system (described for example, below). In some embodiments, the computing device may be a cloud computing node (for example, in the role of a computer server) connected to a cloud computing network (not shown). The computing device may be practiced in distributed cloud computing environments where tasks are performed by remote processing devices that are linked through a communications network. In a distributed cloud computing environment, program modules may be located in both local and remote computer system storage media including memory storage devices (e.g., USB drives).

The computing device may typically include a variety of computer system readable media. Such media could be chosen from any available media that is accessible by the computing device, including non-transitory, volatile, and non-volatile media, removable and non-removable media. The system memory could include random access memory (RAM) and/or a cache memory. A storage system can be provided for reading from and writing to a non-removable, non-volatile magnetic media device. The system memory may include at least one program product having a set (e.g., at least one) of program modules that are configured to carry out the functions of embodiments of the invention. The program product/utility, having a set (at least one) of program modules, may be stored in the system memory. The program modules generally carry out the functions and/or methodologies of embodiments of the invention as described herein.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects “system.” Furthermore, aspects of the disclosed invention may take the form of a computer program product embodied in one or more computer readable media having computer readable program code embodied thereon.

Aspects of the disclosed invention are described above with reference to screen shots, toolbars on screen shots, block diagrams of methods, modules, apparatus (systems) and computer program products according to embodiments of the invention. It will be understood that each screen shot and each block of the block diagrams, and combinations of blocks in the flowchart illustrations and/or block diagrams, can be implemented by computer program instructions.

These computer program instructions may be provided to the processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks or modules.

### Other Embodiments

Although the present invention has been described with reference to teaching, examples, and preferred embodiments, one skilled in the art can easily ascertain its essential characteristics, and without departing from the spirit and scope thereof can make various changes and modifications of the invention to adapt it to various usages and conditions. Those skilled in the art will recognize or be able to ascertain using no more than routine experimentation, many equivalents to the specific embodiments of the invention described herein. Such equivalents are encompassed by the scope of the present invention.

What is claimed is:

1. A programmable calculator and equation solver comprising:
(A) a USB device comprising a software application that can be executed by a computer operating system;
(B) the software application comprising a multiple document interface application capable of displaying multiple documents at the same time, with each document displayed in its own window, the multiple document interface application comprising:
(i) a text entry module that is capable of being used to create, save, and access one or more documents comprising one or more lines of text, each line of text comprising (a) an instruction or comment, (b) one or more mathematical and/or trigonometric formulas, or (c) computer programming language instructions;
(ii) a CALCULATE module comprising the capability of being used to execute the one or more mathematical and/or trigonometric formulas, the CALCULATE module reading the lines of text from top to bottom, the CALCULATE module outputting the results of the executed instructions, and the CALCULATE module being capable of converting the outputted results in different forms comprising numerals, radians, degrees, and/or gradients;
(iii) a RUN module comprising the capability of being used to execute the computer programming language instructions, the RUN module reading the lines of text from top to bottom, the RUN module outputting the results of the executed instructions, and the RUN module being capable of converting the outputted results in different forms comprising numerals, radians, degrees, and/or gradients;
(C) the software application further comprising a solver application, the solver application comprising:
(i) a formula input module that is capable of being used to enter at least one mathematical and/or trigonometric formula that has at least one unknown variable;
(ii) a solver module that is capable of being used to solve the at least one unknown variable in the at least one mathematical and/or trigonometric formula, the solver module being capable of outputting the results of the solution of the at least one unknown variable;
(D) the software application further comprising an optional encryption/decryption function that is capable of encrypting or decrypting the text or selected text within each of the documents; and
(E) the software application further comprising an optional licensing function that is capable of being used to control the use of the software application and limit such use to licensed users.

2. The programmable calculator and equation solver of claim 1 further comprising:
(A) the CALCULATE module further comprises the capability of executing instructions in the mathematical and/or trigonometric formulas containing numerals, degrees, radians, and/or gradients;
(B) the CALCULATE module further comprises the capability of executing instructions of one or more mathematical and/or trigonometric formulas by clicking only one control key;
(C) the software application further comprises the capability of converting the outputted results of the CALCULATE module, the RUN module, and the solver module into degrees, minutes, and seconds; and
(D) the software application further comprises the capability of saving, viewing, loading, and deleting mathematical and/or trigonometric formulas and/or variables in whole or in part in strings that are capable of being used to fill-in text boxes within an input text box.

3. The programmable calculator and equation solver of claim 1, wherein the software application uses Rich Text Format.
